(19) United States
(12) Patent Application Publication
(10) Pub. No.: US 2010/0083305 A1
(43) Pub. Date: Apr. 1, 2010

(54) Interface Device Having Multiple Software Clients to Facilitate Display of Targeted Information

(76) Inventors: Swarup Acharya, New Providence, NJ (US); Anurag Srivastava, New Providence, NJ (US)

Correspondence Address: RYAN, MASON & LEWIS, LLP, 90 FOREST AVENUE, LOCUST VALLEY, NY, 11560, US

(21) Appl. No.: 12/241,400

(22) Filed: Sep. 30, 2008

(51) Int. Cl. H04N 7/025

(52) U.S. Cl. 725/34

(57) ABSTRACT

Advertisements or other types of targeted information are delivered to set-top boxes or other user interface devices of a signal distribution system. In one aspect of the invention, a user interface device comprises at least first and second software clients and a video buffer. The first software client receives packets associated with a first media stream, and the second software client receives packets associated with a second media stream containing the targeted information. The first software client delivers at least a portion of the packets associated with the first media stream to the video buffer. The second software client delivers at least a portion of the packets associated with the second media stream to the video buffer while one or more packets of the first media stream are still in the video buffer. The user interface device switches from the first media stream to the second media stream based on timing information which may be received from an external detection server.

### FIELD OF THE INVENTION

The present invention relates generally to signal distribution systems, and more particularly to techniques for providing targeted advertisements or other types of targeted information within such systems.

### BACKGROUND OF THE INVENTION

Conventional signal distribution systems include, by way of example, cable television systems, satellite television systems, and systems providing Internet protocol television (IPTV) over digital subscriber line (DSL) or fiber. Such systems are configured to distribute media streams associated with subscription television services to system subscribers or other users. Typically, a given subscriber is provided with an interface device, such as a set-top box or receiver, for communicating with system head end equipment. The interface device is configured to permit the subscriber to receive, on a television or other presentation device coupled to the interface device at a given location, the particular subscription television services to which that subscriber is entitled by virtue of the subscription. A given subscription may encompass, by way of example, a number of basic broadcast channels, as well as one or more premium programming channels, such as movie channels, sports channels, specialty channels, pay-per-view channels, on-demand video channels, etc.

A number of techniques are known for providing targeted advertisements in a signal distribution system of the type described above. One example is described in PCT International Publication No. WO 02/47384, entitled “Method and Apparatus for IP Multicast Content Distribution System Having National and Regional Demographically Targeted Advertisement Insertion.” In this technique, demographic targeting of inserted advertisement content is accomplished on a per-stream basis at a regional network level by modifying header information during a packet replication process.

A problem with these and other known techniques is that the advertisement insertion process is typically carried out entirely in head end equipment of the system, so as to be fully transparent to the interface device. Thus, the interface device at the user location is not even aware that the targeted insertion is taking place, and cannot distinguish between a stream having inserted targeted advertisements and an ordinary stream. This type of arrangement unduly limits the flexibility of the system, and may prevent it from achieving a desired level of granularity in its targeting of advertisements to particular groups of users. It also makes it difficult to adapt the insertion process to situations such as a user changing a channel while a targeted advertisement is being played.

These and other problems are addressed by techniques disclosed in U.S. patent application Ser. No. 11/764,472, filed Jun. 18, 2007 and entitled “Targeted Advertisement Insertion with Interface Device Assisted Switching,” which is commonly assigned herewith and incorporated by reference herein. These techniques directly involve a set-top box or other interface device in the insertion process.

However, when the interface device is involved in the insertion process, it can be difficult to precisely coordinate the switching from a content stream to a targeted advertisement among multiple interface devices. For example, significant differences in buffer sizes and fullness levels between set-top boxes can cause some of the set-top boxes to miss initial portions of the targeted advertisements. This problem may be particularly severe in systems that support fast channel change techniques that allow a given set-top box to switch rapidly from one content stream to another content stream.

### SUMMARY OF THE INVENTION

The present invention in the illustrative embodiments provides improved processes for targeted information insertion in a set-top box or other interface device.

In accordance with one aspect of the invention, advertisements or other types of targeted information are delivered to user interface devices of a signal distribution system. A given such user interface device comprises at least first and second software clients and a video buffer. The first software client receives packets associated with a first media stream, and the second software client receives packets associated with a second media stream containing the targeted information. The first software client delivers at least a portion of the packets associated with the first media stream to the video buffer. The second software client delivers at least a portion of the packets associated with the second media stream to the video buffer while one or more packets of the first media stream are still in the video buffer. The user interface device switches from the first media stream to the second media stream based on timing information. The timing information may be received, by way of example, from a detection server that is external to the user interface device.

The second software client may store the packets associated with the second media stream in a storage location outside of the video buffer prior to delivering those packets to the video buffer. The second software client then delivers the packets associated with the second media stream to the video buffer at an insertion point indicated by the timing information. A first packet of the second media stream may be delivered to the video buffer so as to immediately follow a final packet of the first media stream prior to the insertion point.

At a given time prior to the user interface device switching from the first media stream to the second media stream, packets of the first media stream occupy a portion of the video buffer immediately preceding the insertion point and packets of the second media stream occupy a portion of the video buffer immediately following the insertion point.

In a given one of the illustrative embodiments, the first software client comprises a content client configured to receive content packets from an external content server, and the second software client comprises an ad client configured to receive ad packets from an external ad server.

The user interface device may be further configured to subsequently switch back from the second media stream to the first media stream. At a given time prior to the user interface device switching back from the second media stream to the first media stream, packets of the second media stream occupy a portion of the video buffer immediately preceding a designated insertion point and packets of the first media stream occupy a portion of the video buffer immediately following the designated insertion point.

The illustrative embodiments advantageously facilitate the provision of targeted advertisements and other targeted information in a wide variety of signal distribution systems. For example, more precise coordination of the switching from a content stream to a targeted advertisement can be achieved across multiple interface devices. This ensures that initial portions of targeted advertisements are not missed, even in the presence of significant differences in buffer sizes and fullness levels between the interface devices.

### BRIEF DESCRIPTION OF THE DRAWINGS

FIG. 1A shows an illustrative embodiment of a signal distribution system in accordance with the invention.

FIG. 1B shows a simplified block diagram of an interface device of the FIG. 1A system.

FIG. 2 is a more detailed view of a portion of a signal distribution system in an illustrative embodiment.

FIG. 3 illustrates an interface device of the FIG. 2 system having separate content and ad software clients that interact with respective content and ad servers.

FIG. 4 is a flow diagram of a process for targeted information insertion in an illustrative embodiment.

### DETAILED DESCRIPTION OF THE INVENTION

The invention will be illustrated herein in conjunction with illustrative embodiments of signal distribution systems and associated targeted advertisement insertion techniques. It should be understood, however, that the invention is not limited to use with the particular systems and techniques described, but is instead more generally applicable to any signal distribution application in which it is desirable to provide enhanced flexibility and effectiveness in delivery of targeted advertisements. For example, although described herein primarily in the context of television services, the techniques of the invention can also be adapted in a straightforward manner to audio services, such as subscription audio services delivered via digital satellite radio systems. Systems of the latter type are considered a type of signal distribution system as that term is used herein.

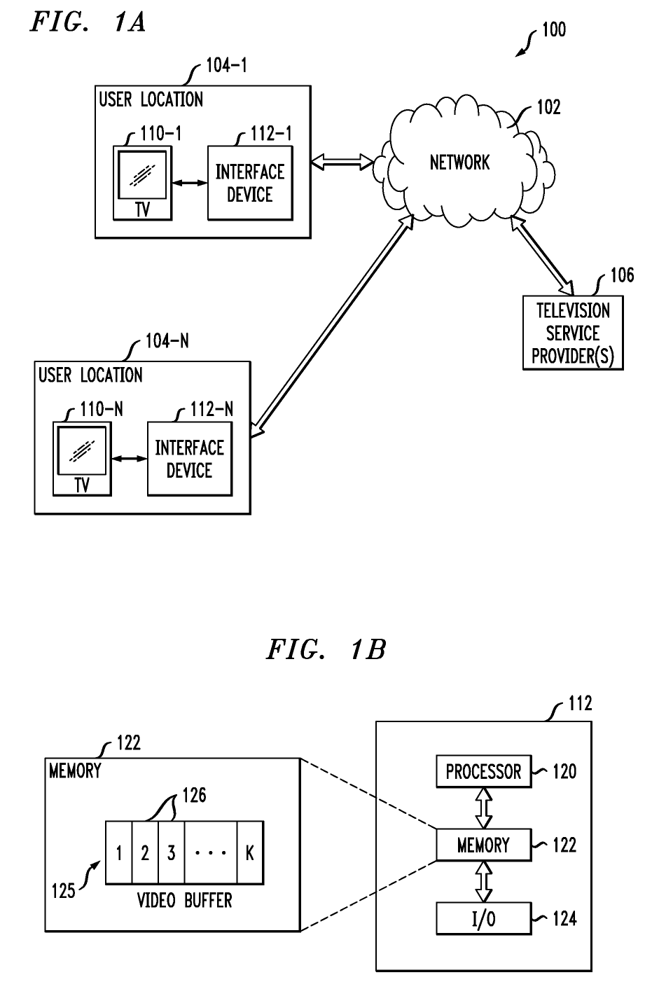

Referring now to FIG. 1A, a signal distribution system 100 comprises a network 102 over which equipment at user locations 104-1 through 104-N communicates with one or more television service providers 106. The signal distribution system 100 may comprise, by way of example, a cable television system, a satellite television system, an IPTV system, or portions or combinations of these and other systems. Element 106 may comprise otherwise conventional service provider equipment, including, for example, head end systems, satellites, servers, etc. The equipment at a given location 104-i, i=1, . . . N, comprises a television 110-i coupled to an interface device 112-i. The interface devices 112 for purposes of the illustrative embodiments will be assumed to be set-top boxes (STBs), but in other embodiments may comprise, for example, receivers, computers, or other processor-based devices, in any combination. Such devices are also referred to herein as user interface devices. A given device of this type allows one or more users to access media streams that are delivered to the device via other elements of the signal distribution system.

The network 102 may comprise any type of communication network suitable for transporting signals associated with the provision of television services, and the invention is not limited in this regard. For example, portions of the network 102 may comprise local networks, wide area networks, the Internet, etc.

A given one of the locations 104 may comprise, for example, a designated home location of a particular system subscriber. Thus, it is a location at which the subscriber is permitted to access one or more television services by virtue of his or her subscription. It should be noted that the term “subscriber” as used herein is intended to encompass other subscribing entities, such as businesses or organizations, in addition to individuals or families. Subscribers may be viewed as examples of what are more generally referred to herein as users, and the term “user” is thus intended to include subscribers as well as other types of users. Also, the term “home” should be construed broadly, and is not intended to be restricted to individual or family residences. Instead, the home location of a particular subscriber may be any location at which that subscriber ordinarily accesses television services in accordance with the subscription. A home location may therefore be at a business facility, hotel or other building, in a means of conveyance such as an automobile, train, bus or airplane, or at any other suitable location.

The techniques of the present invention may be utilized in conjunction with the provision of subscription television services to roaming users. In such an arrangement, one of the locations 104 may be a home location of a given subscriber and another of the locations may be a remote location of that subscriber. Additional details regarding roaming subscription television services may be found in, for example, U.S. patent application Ser. No. 11/130,329, filed May 16, 2005 and entitled “Method and Apparatus for Providing Remote Access to Subscription Television Services,” U.S. patent application Ser. No. 11/399,726, filed Apr. 7, 2006 and entitled “Method And Apparatus for Delivering Subscription Service Content to Roaming Users,” U.S. patent application Ser. No. 11/399,872, filed Apr. 7, 2006 and entitled “Delivery of Subscription Services to Roaming Users Through Head End Equipment,” and U.S. patent application Ser. No. 11/425,566, filed Jun. 21, 2006 and entitled “User Interface Methods and Apparatus for Roaming Access to Subscription Services,” all commonly assigned herewith and incorporated by reference herein.

Other aspects of exemplary signal distribution systems in which the techniques of the present invention may be implemented are described in U.S. patent application Ser. No. 11/145,832, filed Jun. 6, 2005 and entitled “Signal Distribution System with User-Defined Channel Comprising Information from an External Network,” and U.S. patent application Ser. No. 11/427,879, filed Jun. 30, 2006 and entitled “Signal Distribution System with Interrupt Processing and Trick Play Functionality,” both commonly assigned herewith and incorporated by reference herein.

It is to be appreciated that the invention does not require any particular geographic relationship between the various user locations 104. Accordingly, the locations may all be within the same local area, served by a common service provider. As another example, two or more of the locations may be more geographically remote from one another, such as in different regions of the same country, or even in different countries, with the two locations being serviced by different television service providers. It is also possible that two or more of the locations may be in a common building or other structure, for example, in respective first and second apartments of an apartment building. Numerous alternative arrangements are possible, as will be apparent to those skilled in the art.

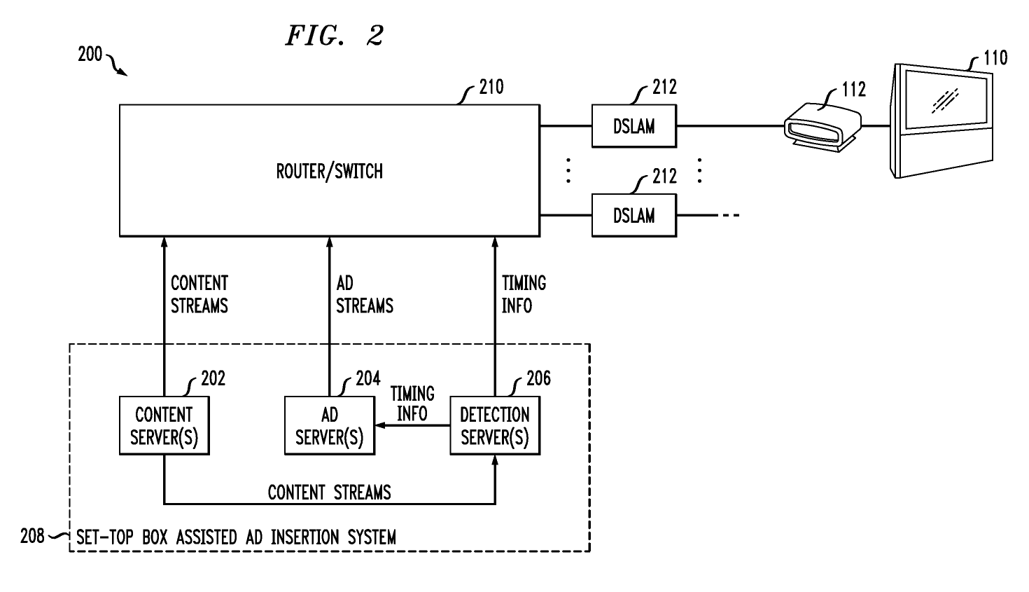

FIG. 1B illustrates that a given one of the interface devices 112 comprises a processor 120, a memory 122, and input/output (I/O) elements 124. The processor 120 may be, e.g., a microprocessor, a microcontroller, an application-specific integrated circuit (ASIC) or other type of processing device, as well as portions or combinations of such devices. The memory 122 may include an electronic random access memory (RAM), a read-only memory (ROM) or other type of storage device, as well as portions or combinations of such devices. The processor 120 and memory 122 are used in storage and execution of one or more software programs for assisting in targeted advertisement insertion, as will be described in greater detail below. For example, software programs for implementing separate content and advertisement software clients may be downloaded to or otherwise stored in the memory 122 and executed by the processor 120 in order to facilitate targeted ad insertion in the system. More detailed examples of such arrangements will be described below in conjunction with FIGS. 2 through 4.

Memory 122 may be viewed as an example of what is also referred to herein as a computer-readable storage medium.

The memory 122 in this embodiment further comprises a video buffer 125. The video buffer includes a plurality of storage locations 126 which are generally utilized to store respective packets of a media stream that is being delivered to a corresponding television 110 for display. The video buffer may thus be viewed, by way of example, as a primary video buffer from which video packets are decoded and displayed on a television or other output presentation device of the system.

The video buffer is assumed to be implemented as a first-in first-out (FIFO) buffer configured to store K packets, with packet 1 denoting the first-in packet and packet K denoting the last-in packet. As the packets are retrieved from the buffer and displayed, the buffer contents shift from right to left such that additional packets can be stored. The term “packet” as used in this context and elsewhere herein is intended to be construed broadly, and does not require any particular header or payload configuration.

Other embodiments may utilize other types of video buffers. For example, such embodiments may utilize priority buffers that permit later-arriving packets to be retrieved before earlier-arriving packets.

The particular signal distribution system configuration shown and described in conjunction with FIG. 1 should be viewed as an illustrative example of such a system, and it is to be understood that the invention can be implemented using other types and configurations of system components.

The present invention in an illustrative embodiment deals with delivery of targeted advertisements to users via an IPTV system. It is to be appreciated that the described techniques can be extended in a straightforward manner to be implemented using other types of systems, such as cable or satellite television systems.

A targeted advertisement insertion technique in this embodiment involves configuring the interface device 112 to include first and second software clients. The first and second software clients interact with respective content and ad servers of the signal distribution system to receive respective content and ad streams. These software clients are configured to direct packets from the respective content and ad streams into the video buffer 125 of the interface device, such that the final packets of the content stream prior to an indicated switch from the content stream to the ad stream are followed immediately in the buffer by the initial packets of the ad stream. The interface device switches from the content stream to the ad stream based on timing information received from an external detection server. Just prior to the switch, packets of the ad stream are already stored in the video buffer even though one or more packets of the content stream are still in the video buffer. A similar process is utilized to allow the interface device to return from the ad stream to the content stream at the appropriate time.

The above-noted targeted advertisement insertion technique will now be described in greater detail with reference to FIGS. 2, 3 and 4. Again, it will be assumed for description of these illustrative embodiments that the interface device 112 is an STB, although other types of interface devices could be used.

FIG. 2 shows a more detailed view of one possible implementation of a portion of the system 100. In this embodiment, the network 102 comprises an IP network over which multiple streams are delivered to STB 112 via IPTV head end equipment associated with a television service provider 106. The advertisement insertion process in this embodiment and others described herein may be implemented at least in part in the form of software that is executed by system elements such as one or more interface devices and equipment of one or more television service providers. Again, although illustrated in the context of IPTV, the described services can be adapted in a straightforward manner for use in other types of signal distribution systems, such as cable and satellite television systems.

It is assumed in the FIG. 2 embodiment that targeted ad streams are not cached or otherwise locally available at the STB 112. Instead, such streams are delivered to the STB in substantially real time. The present embodiment therefore avoids the need to pre-push targeted advertisements to the STB for local storage.

In the FIG. 2 arrangement, a portion 200 of system 100 comprises one or more content servers 202, one or more ad servers 204, and one or more detection servers 206. The servers are part of a set-top box assisted ad insertion system 208. These elements in the present embodiment are assumed to be associated with television service provider 106, but could alternatively be associated with other system elements. The servers 202, 204 and 206 may each comprise separate stand-alone servers, or two or more of them may be implemented on a common processing platform. For example, these servers may be implemented as servlets of a larger ad insertion system server.

The detection server(s) 206 is an example of what is more generally referred to herein as an external detection server. It is referred to as external in that it is located external to the STB 112. Alternative embodiments could be configured to detect ad cues at least in part within the STB.

The servers 202, 204 and 206 are coupled to a network element 210 which in this embodiment illustratively comprises a router or switch of the IP network. For example, the network element 210 may comprise a Gigabit Ethernet switch or other video switch suitable for processing streams for transmission to the STB 112. Network element 210 is coupled via DSL access multiplexers (DSLAMs) 212 to the STB 112 and other STBs which are not explicitly shown in this figure.

In an alternative embodiment, one or more of the servers 202,204 and 206 may instead be implemented in whole or in part internally to the network element 210, utilizing one or more line cards or other processing devices of that network element.

A content stream generated by content server 202 is provided via network element 210 and DSLAM 212 to the STB 112. The content stream is also provided to detection server 206. The detection server processes the content stream to detect ad markers or other ad cues in that stream. The detection server utilizes the detected ad cues to generate timing information. For example, the detected cues may be utilized to provide timing information indicating the beginning and duration of a given ad slot in the content stream. The ad cues may comprise, by way of example, conventional SCTE-35 signaling messages inserted into packets of an MPEG stream. In one embodiment, the detection server parses program association table (PAT) and program map table (PMT) information in an MPEG header to obtain the program identifier (PID) of an elementary stream (ES) carrying the ad cues, and monitors the ES to locate packets containing the ad cues. When these packets are found, usually about 8-10 seconds before the corresponding ad slot, they are processed to obtain the precise timing information as described by a corresponding presentation time stamp (PTS).

The timing information determined by the detection server 206 from the detected ad cues is signaled to the ad server 204 and the STB 112.

The timing information may be communicated by the detection server 206 to the STB 112 using a short message on a signaling channel. For example, a short message such as “CHANNEL=2, START_PTS=413245896, DURATION=60000” transmitted on a multicast channel may be used to inform multiple STBs that a 60-second ad slot is about to come on Channel 2 starting at the specified video PTS. It should be noted that such timing information need not be transmitted via multicast, but could instead utilize unicast, proprietary signaling, or other types of communication, in any combination.

The STB 112 may request the timing information from the ad insertion system 208. For example, if a user changes a channel on the STB, the STB may respond by requesting timing information for the new channel.

The remote detection approach illustrated in FIG. 2 conserves STB resources by eliminating the need for each STB to monitor for ad cues, and can be implemented using a small signaling overhead. This remote detection approach also allows monitoring of ad slots on all channels at all times irrespective of the currently played channel. Using remote detection, if a user commands the STB to switch to a channel that is currently in an ad slot, the STB can temporarily ignore the channel change request and instead switch to an appropriate targeted ad stream. Based on the timing information for the new channel as supplied by the detection server, the STB can calculate the remaining ad slot time and return the user to the requested channel after that time interval.

The ad server 204 utilizes the timing information provided by the detection server 206 to start one or more ad streams. Thus, the ad streams are started at the appropriate times as indicated by the timing information. These streams are delivered to the STB 112 via the network element 210 and DSLAM 212.

A number of different techniques may be used to start the ad streams. For example, the ad server 204 may start the ad streams at times indicated by the detection server 206. These ad streams are started at the precise times as communicated by the detection server, and do not pass through the detection server.

The STB 112 utilizes the timing information previously provided to it by the detection server 206 to join the appropriate ad streams at the appropriate times. The STB thus switches from a content stream to an ad stream at an appropriate time as determined based on the timing information. The timing information is also utilized to allow the STB to return from the ad stream to the content stream at the appropriate time. For example, as noted above, the timing information may include a specified duration of the targeted ad. The STB can thus start a timer when it switches to the ad stream, and then switch back to the original stream when the timer expires. The stream switching in the STB may also or alternatively make use of conventional signaling protocols, such as Internet group management protocol (IGMP). For example, such protocols may be used to allow the STB to join a multicast group that is to receive a particular ad stream.

Additional details regarding the operation of an ad insertion system of the type described above can be found in the above-cited U.S. patent application Ser. No. 11/764,472.

As indicated previously herein, when the STB is involved in the ad insertion process, it can be difficult to precisely coordinate the switching from a content stream to an ad stream among multiple STBs. This may be attributable to significant differences in buffer sizes and buffer fullness levels between the STBs, which can cause some of the STBs to miss initial portions of targeted ads.

The illustrative embodiments address this problem by configuring the STB 112 to include separate software clients for interfacing with respective ones of the content server 202 and ad server 204. This allows packets of an ad stream to be stored in the video buffer 125 contemporaneously with one or more packets of a content stream that are stored in that buffer, which facilitates accurate switching between from a content stream to an ad stream. For example, one software client can interact with an ad server to obtain packets of an ad stream and store those packets into a memory location from which they can be easily copied into the video buffer when needed, while another software client interacts with a content server to obtain packets of a content stream that are delivered to the video buffer.

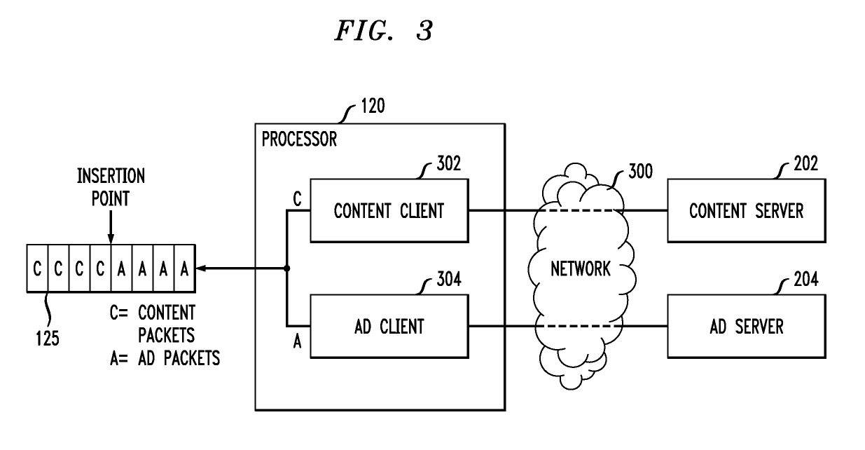

Referring now to FIG. 3, processor 120 is configured to drive the video buffer 125. The processor 120 implements a content client 302 and an ad client 304. These separate software clients communicate over a network 300 with content server 202 and ad server 204, respectively. Each of these clients is a separate entity, implemented as an identifiable piece of software, that communicates with a particular type of external server to receive content or ad stream packets therefrom. Such software can be written in C, C++, Java, or any other suitable programming language.

Both of the software clients 302 and 304 are able to independently receive packets and store them in the video buffer 125. As indicated in the figure, both content packets (C) received by the content client 302 and ad packets (A) received by the ad client 304 may be stored simultaneously in the video buffer. More specifically, content packets continue to be stored in the video buffer up to a particular ad insertion point at which point the last content packet prior to the insertion point is immediately followed by an initial ad packet of the ad stream.

The software clients 302 and 304 may initially store respective content and ad packets outside of the video buffer 125, for example, in other portions of the memory 122. The clients can then copy these packets over to the video buffer at an appropriate time in accordance with current channel selection and ad cue timing information. However, as indicated previously, it is assumed that the ad packets are delivered to the STB in substantially real time rather than, for example, being pushed to the STB for local storage well before they are needed.

In a fast channel change environment, initial portions of a given content stream for a new channel may be sent via unicast transmission from the ad server 204 to the STB 112. The STB may then eventually migrate to the appropriate multicast stream for the new channel. Depending on the particular point in time that the channel was changed, that STB may receive more unicast content packets than another STB that switched the channel at a different time. This can lead to differences in buffer fullness in the STBs that can delay the display of ad packets. Similar issues can arise if the STBs have different size video buffers.

The FIG. 3 embodiment utilizes the separate ad client 304 to ensure that ad packets can be stored in the video buffer 125 immediately following an identified ad insertion point in the content stream. The trigger for storing the ad packets in the video buffer may be identification of the last content packet prior to the insertion point as indicated by the ad cue based timing information supplied to the STB from the detection server 206. Other triggers may be used, such as the presence of empty storage locations in the buffer.

The content client 302 and ad client 304 may be viewed as separate video sources that both write to the same primary video buffer.

In a given system, it is generally desirable for all of the STBs that are to receive a given targeted ad to switch to that ad simultaneously. For example, DSLAM based systems such as that shown in FIG. 2 can often only switch from a content stream to an ad stream at a single time for a given group of STBs. If at that particular switching time the video buffers of the respective STBs are not similarly situated in terms of size and fullness, there may be some significant delay from one STB to another before the first ad stream packets are displayed. The use of separate software clients for receiving and storing content and ad stream packets as shown in FIG. 3 ensures that each STB can display the appropriate initial ad packets even if their respective buffers are at different fullness levels.

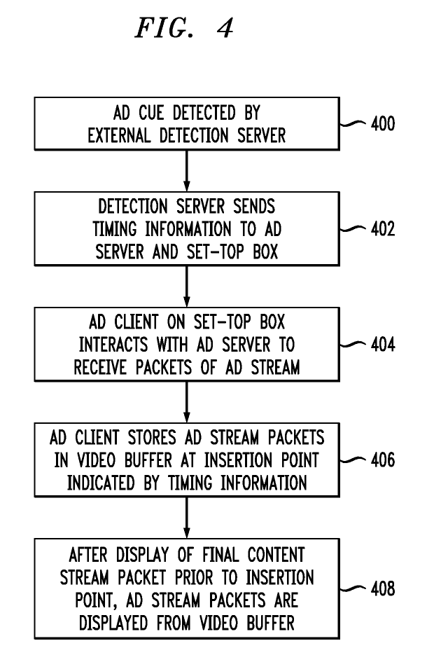

FIG. 4 shows steps 400 through 408 of an exemplary targeted advertisement insertion process implemented in the signal distribution system as illustrated in FIGS. 2 and 3.

In step 400, an ad cue is detected in a given content stream by detection server 206.

In step 402, the detection server 206 sends timing information based on the detected ad cue to the ad server 204 and the STB 112.

In step 404, the ad client 304 on the STB 112 interacts with the ad server 204 to receive packets of an ad stream to be inserted.

In step 406, the ad client 304 stores the ad stream packets in the video buffer 125 at an insertion point indicated by the timing information. As indicated above, the video buffer at this point contains one or more content packets of the content stream as well as one or more ad packets of the ad stream. Thus, content stream and ad stream packets concurrently occupy the video buffer, so as to facilitate display of initial ad stream packets immediately following display of a final packet of the content stream just prior to the insertion point.

In step 408, the ad stream packets are displayed from the video buffer following display of the final content stream packet prior to the insertion point.

The particular process steps shown in FIG. 4 are presented by way of illustrative example only, and other process steps may be used in other embodiments. Also, although the FIG. 4 process is described with reference to targeted advertisements, it is contemplated that the process could be applied to other types of targeted information, such as, for example, custom program guides, on-demand video screens, etc.

The illustrative embodiments described above provide more precise coordination of the switching from a content stream to a targeted ad stream across multiple STBs. This ensures that initial portions of targeted ads are not missed, even in the presence of significant differences in buffer sizes and fullness levels between the STBs. In these embodiments, when an STB performs a switch from a content stream to an ad stream, it immediately finds a certain number of ad stream packets in the video buffer, and does not have to wait to fill the buffer with ad packets. This leads to significantly reduced latency in switching from a content stream to an ad stream.

The above-described embodiments of the invention are intended to be illustrative only. For example, as indicated above, the techniques can be applied to a wide variety of media delivery services, including audio services delivered via digital satellite radio, and to other arrangements for delivering signals associated with subscription or non-subscription media services. Further, the media streams that are delivered to an interface device associated with a given user may include any type of data, including, for example, audio, video, speech or other information signals, in any combination.

These and numerous other alternative embodiments within the scope of the following claims will be readily apparent to those skilled in the art.

We claim:

1. A method of processing targeted information delivered to a user interface device in a signal distribution system, the user interface device comprising at least first and second software clients and a video buffer, the method comprising the steps of:
the first software client receiving packets associated with a first media stream; and
the second software client receiving packets associated with a second media stream containing the targeted information;
wherein the user interface device switches from the first media stream to the second media stream based on timing information;
wherein the first software client delivers at least a portion of the packets associated with the first media stream to the video buffer; and
wherein the second software client delivers at least a portion of the packets associated with the second media stream to the video buffer while one or more packets of the first media stream are still in the video buffer.

2. The method of claim 1 further comprising the step of the second software client storing the packets associated with the second media stream in a storage location outside of the video buffer prior to delivering said packets to the video buffer.

3. The method of claim 1 wherein the second software client delivers the packets associated with the second media stream to the video buffer at an insertion point indicated by the timing information.

4. The method of claim 3 wherein a first packet of the second media stream is delivered to the video buffer so as to immediately follow a final packet of the first media stream prior to the insertion point.

5. The method of claim 1 wherein the first software client comprises a content client configured to receive content packets from an external content server.

6. The method of claim 1 wherein the second software client comprises an ad client configured to receive ad packets from an external ad server.

7. The method of claim 1 wherein the targeted information comprises at least one targeted advertisement.

8. The method of claim 1 wherein the timing information is received from a detection server that is external to the user interface device.

9. The method of claim 1 wherein at a given time prior to the user interface device switching from the first media stream to the second media stream, packets of the first media stream occupy a portion of the video buffer immediately preceding a designated insertion point and packets of the second media stream occupy a portion of the video buffer immediately following the designated insertion point.

10. The method of claim 1 wherein the user interface device subsequently switches back from the second media stream to the first media stream.

11. The method of claim 10 wherein at a given time prior to the user interface device switching back from the second media stream to the first media stream, packets of the second media stream occupy a portion of the video buffer immediately preceding a designated insertion point and packets of the first media stream occupy a portion of the video buffer immediately following the designated insertion point.

12. A user interface device for a signal distribution system, the user interface device comprising:
a memory comprising a video buffer;
a processor coupled to a memory; and
interface circuitry configured to receive media streams from at least one network element of the signal distribution system;
wherein the processor implements first and second software clients;
the first software client receiving packets associated with a first media stream; and
the second software client receiving packets associated with a second media stream containing targeted information;
wherein the user interface device switches from the first media stream to the second media stream based on timing information;
wherein the first software client delivers at least a portion of the packets associated with the first media stream to the video buffer; and
wherein the second software client delivers at least a portion of the packets associated with the second media stream to the video buffer while one or more packets of the first media stream are still in the video buffer.

13. The interface device of claim 12 wherein said interface device comprises a set-top box of the signal distribution system.

14. The interface device of claim 12 wherein the memory comprises additional storage locations outside of the video buffer and the second software client stores the packets associated with the second media stream in one or more of the storage locations outside of the video buffer prior to delivering said packets to the video buffer.

15. The interface device of claim 12 wherein the timing information is received from a detection server that is external to the interface device and the second software client delivers the packets associated with the second media stream to the video buffer at an insertion point indicated by the timing information.

16. The interface device of claim 15 wherein a first packet of the second media stream is delivered to the video buffer so as to immediately follow a final packet of the first media stream prior to the insertion point.

17. The interface device of claim 12 wherein the first software client comprises a content client configured to receive content packets from an external content server.

18. The interface device of claim 12 wherein the second software client comprises an ad client configured to receive ad packets from an external ad server.

19. The interface device of claim 12 wherein at a given time prior to the user interface device switching from the first media stream to the second media stream, packets of the first media stream occupy a portion of the video buffer immediately preceding a designated insertion point and packets of the second media stream occupy a portion of the video buffer immediately following the designated insertion point.

20. A computer-readable storage medium having executable program code embodied therein, wherein the program code when executed in a user interface device implements at least first and second software clients;
the first software client receiving packets associated with a first media stream;
the second software client receiving packets associated with a second media stream containing targeted information;
wherein the user interface device switches from the first media stream to the second media stream based on timing information;
wherein the first software client delivers at least a portion of the packets associated with the first media stream to a video buffer of the user interface device; and
wherein the second software client delivers at least a portion of the packets associated with the second media stream to the video buffer while one or more packets of the first media stream are in the video buffer.
